(19) United States
(12) Patent Application Publication
(10) Pub. No.: US 2010/0223446 A1
(43) Pub. Date: Sep. 2, 2010

(54) CONTEXTUAL TRACING

(75) Inventors: Sanjeev Katariya, Bellevue, WA (US); Jwalin Buch, Kirkland, WA (US); Gueorgui Bonov Chkodrov, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/395,555

(22) Filed: Feb. 27, 2009

(51) Int. Cl. G06F 9/30; G06F 17/30

(52) U.S. Cl. 712/220; 707/E17.009; 712/E09.032

(57) ABSTRACT

A method of tracking execution of activities in a computing environment in which events in an activity are recorded along with an activity identifier uniquely identifying the activity and tying the events to the activity. To track interactions between activities, a correlation identifier may be generated and transferred between the interacting activities as part of the interaction. For each of the activities participating in the interaction, information on an event relating to the interaction is recorded along with the correlation identifier. The correlation identifier thus allows uniquely identifying each interaction which may be used to synchronize streams of events within the activities at points of their interaction. Activities may interact across any boundary, including a network.

### BACKGROUND

Tracing is a technique employed within computer systems to monitor and improve the overall quality of the computer system. During tracing, data is gathered concerning events that occur during execution of application programs and other components. As events, such as a call to a particular utility within an operating system, occur, an indication of the event may be made in a log file.

The recorded events lay out a sequence of events that occurred and may provide insight into the cause of a problem. If problems occur, the log file may be analyzed by a software developer to determine the cause of the problem so that improvements can be made to future versions of the application or other component that experienced problems.

For example, the WINDOWS® operating system provided by Microsoft Corporation of Redmond, Wash., USA, includes a service, called (ETW) for recording event traces. That service supports “hooks” or “instrumentation points” that define points in executing code where an event is logged. Such instrumentation points may be included in software that implements an interface between a process executing an application program component and the operating system.

Each recorded event may include information that facilitates analysis of the stream of recorded event. Recorded information may include an identifier for the process or application component that initiated the event, the nature of the event, such as a call to a specific operating system utility and the value of the system timer when the event occurred.

As computer systems become increasingly complex, multiple components of a computer system may be involved in executing a task. These components may give rise to multiple “activities.” An activity is a schedulable software component, at any level of granularity. An operating system may schedule these activities so that multiple activities may execute concurrently. Each activity, for example, may be said to execute in a different process, task or thread. In this scenario, activities may interact. Interaction with another activity may be an event that is logged for event tracing.

Moreover, interactions between activities may extend to activities beyond a single computer system. Applications increasingly communicate with web services or may be part of a transaction executed on multiple computers in a cluster. Even when an activity interacts with an activity on another computer, it may log that interaction as an event.

### SUMMARY

The inventors have recognized and appreciated that performance management, diagnostics, fault detection, debugging of a computer system and other functions that use event tracing can be improved by recording as part of the event trace information that allows events in a trace log to be understood in the context in which they occur. In scenarios in which an event involves interaction between multiple activities, that information may include a correlation identifier that is stored in connection with events for all of the interacting activities. In this way, when the event logs are analyzed, the event streams associated with the separate activities can be synchronized at the points in time in which they interacted.

To allow activities to record a correlation identifier, an instrumentation point associated with an event that involves interaction with another activity may generate a unique correlation identifier. The instrumentation point in the activity initiating an exchange of data defining the interaction may both record the correlation identifier as part of the event of initiating the exchange of data and supply the correlation identifier to other activities. A recipient activity can then record the correlation identifier as part of the event of receiving the data defining the interaction.

This sharing of correlation identifiers may occur between activities on the same computing device or different computing devices. Though, the format of data exchanged may depend on the locations of the interacting activities. If on the same computing device, the correlation identifier may be passed through an inter-process queue as part of a work packet. If the interacting activities are located on separate computers interconnected by a network, the correlation identifier may be passed in packet header or other portion of a packet used to convey over the network information that is part of the interaction between activities.

In this way, correlation identifiers recorded in trace logs can be used to uniquely identify specific interactions between activities, which can then be used to synchronize streams of events occurring in the activities to thus obtain a reliable view of the context in which activities executed in a computer system. A better contextual view leads to improved management of the system, including more efficient identification and correction of problems.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a computer system in which some embodiments of the invention may be implemented;

FIG. 2 is block diagram of a computing environment in which some embodiments of the invention may be implemented;

FIG. 3 is a sketch illustrating interaction between activities according to some embodiments of the invention;

FIG. 4 is a flowchart of a process of operating a computer system using contextual tracing according to some embodiments of the invention;

FIG. 5 is a sketch of states and state transitions of an activity according to some embodiments of the invention;

FIG. 6 is a flowchart of a process of tracking an activity of interacting activities according to some embodiments of the invention;

FIG. 7 is a flowchart of a process of tracking another activity of interacting activities according to some embodiments of the invention;

FIG. 8 is a flowchart of a process of data transfer between interacting activities according to some embodiments of the invention;

FIG. 9 is a schematic illustration of an event log according to some embodiments of the invention; and

FIG. 10 is a sketch of a display generated from the event log of FIG. 9 showing streams of events synchronized according to some embodiments of the invention.

### DETAILED DESCRIPTION

The inventors have recognized and appreciated that current event tracing systems could be improved by recording, as part of events, information that better allows the context in which an event occurred to be identified. For example, a developer may more quickly and accurately identify a problem in a scenario where multiple activities are active if the events in one activity can be correlated to the events in the other activities. Though time stamps associated with known event tracing systems provide information that can be useful in this regard, the time stamps alone may provide inaccurate or incomplete information. For example, when activities execute on different computing devices, the time stamps for events from each activity may be based on a different time references, such that they are not readily correlated. Even when executed on the same device, the many activities scheduled in a system may lead to different time stamps being recorded when an initiating activity sends data initiating an interaction and when an activity receives the data.

The inventors have recognized and appreciated that an identifier may be utilized to mark an interaction point between activities to then correlate different streams of events in the activities using the interaction point. This identifier acts as a correlation identifier and may be generated and transferred from one activity to another as they interact. Information on events relating to the interaction may be recorded along with the correlation identifier for both of the interacting activities. For example, when one activity sends data to another activity, both the sending and the receiving activity may record relevant information along with the correlation identifier generated for this particular data transfer. When the logged events for each activity are separated into separate streams representing events within each activity, the events stream may thus be synchronized using the correlation identifiers to define points in time when the streams of event coincide.

Though the present invention is not limited by the environment in which it is implemented, the inventors have recognized and appreciated the contextual tracing model can be beneficial in a setting where interacting activities are executed by components communicating over a boundary, such as a network. In such scenarios, it may not be straightforward to track interactions between multiple executing activities and to synchronize their respective events streams. Conventional approaches of using time stamps may not be efficient since different computing devices have different clocks. Thus, the correlation identifiers employed in addition to activity identifiers to uniquely identify each interaction between the activities and possibly other events, improve and simplify synchronization of the events streams.

In some embodiments, when multiple computing devices (e.g., in “cloud computing” environment) cooperate to perform a transaction, events relating to interaction of the activities on each computing device may be recorded along with correlation identifiers generated for the interaction. The correlation identifiers may be transferred as part of a header of a packet carrying data shared between the activities across a network. The packet may be sent in accordance with a network protocol such as, for example, IPv4 or IPv6. Different fields of the headers may be employed to transfer information related to the interaction across a network boundary.

Any suitable components may execute activities in a computing environment. Thus, a single computing device, computing devices in client/server architecture, computing devices in a distributed computing environment may be utilized. Furthermore, different operating systems may be employed.

The inventors also have appreciated and recognized that sizes of the identifiers for activities and correlation identifiers in event logs may be selected to limit the amount of resources used to transfer and store the identifiers. In some embodiments, a size of the activity identifier may be based on duration of time interval during which activities employing the identifier are monitored. A size of the correlation identifier may be based on a rate of data transfer between interacting activities utilizing the correlation identifiers. Other parameters such as a workload, network protocols utilized to transfer data and others may also be used to determine appropriate sizes for the activity and correlation identifiers.

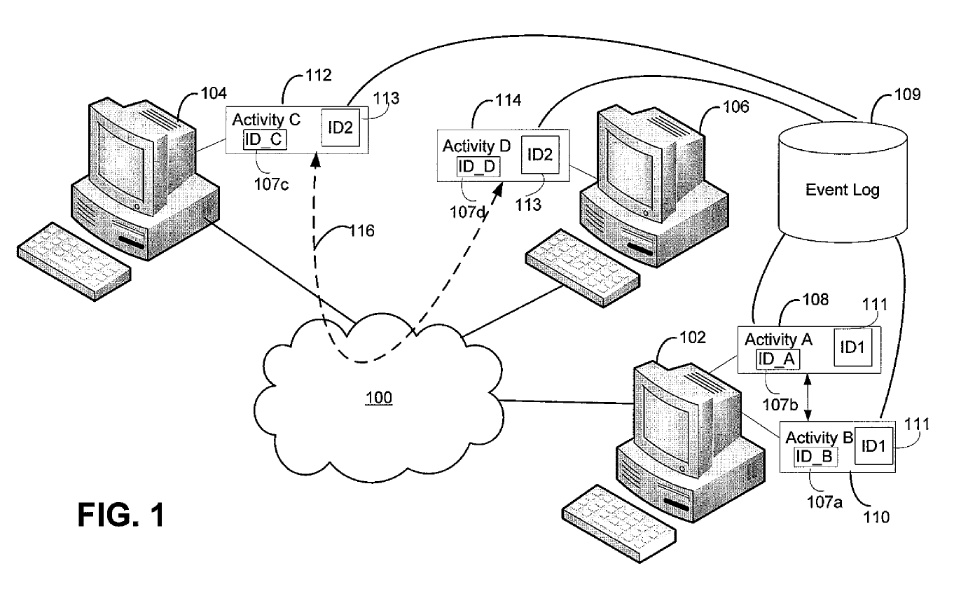

FIG. 1 provides an example of a computer system in which some embodiments of the invention may be employed. Though the invention is not limited to use in any specific setting, FIG. 1 shows a network 100 that provides interconnectivity between multiple computing devices. Network 100 may be, for example, a local area network (LAN), a wide area network (WAN) or any other suitable network. Multiple computing devices, of which devices 102, 104 and 106 are illustrated, may be connected to network 100. Each computing device may be connected to the network in any suitable way. However, the invention is not limited to computing devices connected to a network and may be implemented in a device that is not connected to a network.

Each of the computing devices may log events to support contextual tracing according to embodiments of the invention. Thus, events occurring in activities executed on any of the devices 102, 104 and 106 and associated information may be recorded and later analyzed in the context in which they occurred. To support event logging, each activity may be assigned an activity identifier and events within the activity may be recorded along with the activity identifier. Furthermore, when two or more activities interact, a correlation identifier may be generated to be transferred between the interacting activities to uniquely identify the interaction. An event associated with that interaction may be logged in each of the activities, including the correlation identifier.

Computing device 102 is schematically shown to execute an activity A 108 and an activity B 110 each having a respective activity identifier that uniquely identifies the activity. Accordingly, activity A 108 includes an activity identifier 107a schematically shown as “ID_A” and activity B 110 includes an activity identifier 107b schematically shown as “ID_B.” In this example, activities A 108 and B 110 may interact. Therefore, these activities share a correlation identifier 111 schematically shown an “ID1.” The correlation identifier 111 is used to uniquely identify the interaction between the activities A 108 and B 110 which allows synchronizing streams of events within each of the activities at a point of the interaction.

Correlation identifiers may be used to pinpoint specific points in the execution of an activity where an interaction occurred. An interaction may include information, commands or other data being received from another activity or sent to another activity. Both a sender and a receiver of data share the same correlation identifier, thus enabling analysis tools to “build a bridge” between the two different activities.

Events that occur within activities executed in the computer system shown in FIG. 1 may be logged in storage such as an event log 109. It should be appreciated that event log 109 is shown as one separate component by way of example only. Each of computing devices 102, 104 and 106 may have its own event log. Alternatively, event log 109 may be located within any of the computing devices 102, 104 and 106 or at any other suitable device. Further, event log 109 may comprise more than one mechanism, such as a database, to organize logged events.

In this example, computing devices 104 and 106 may interact over network 100. Thus, activity C 112 executed in device 104 and having an activity identifier 107c shown as “ID_C” may interact with activity D 114 executed in device 106 and having an activity identifier 107d shown as “ID_D” over network 100. The activities C and D may interact over network 100 as shown by an arrow 116. For example, the activities C and D may exchange data over network 100. A correlation identifier 113 shown as “ID2” may be generated for the interaction between the activities C and D and then transferred between the activities as part of the interaction.

Information related to the interaction may be marked with correlation identifier 113 and an event logged for each of the interacting activities C and D. Activity identifiers 107c and 107d allow identifying recorded events that occurred within each of the activities C and D, respectively. When activity C transfers data to activity D, an indication that the data transfer was initiated may be recorded along with correlation identifier 113 in a store such as event log 109. Similarly, when activity D receives data from activity C, an indication that the data transfer was initiated may be recorded along with correlation identifier 113 in a store such as event log 109.

In some embodiments, the data passed between interacting activities may be a work packet used for inter-process communication in a multi-threaded operating system. Correlation identifier 113 may be placed in a work packet generated in one of the interacting activities C and D. For example, when activity C initiates an interaction with activity D, the work packet may be generated in the activity C. Correlation identifier 113 may then be stored in the work packet.

In some embodiments, an activity sends a work packet to another activity with which is interacts by placing it in a queue. Thus, activity C may place data to be transferred to activity D to a queue. The data may comprise the work packet including correlation identifier 113. Activity D may then receive the work packet from the queue. The work packet may then be processed by the activity D to extract correlation identifier 113. For the activity D, any logged information related to the interaction may then be marked with correlation identifier 113 and recorded in a store such as event log 109.

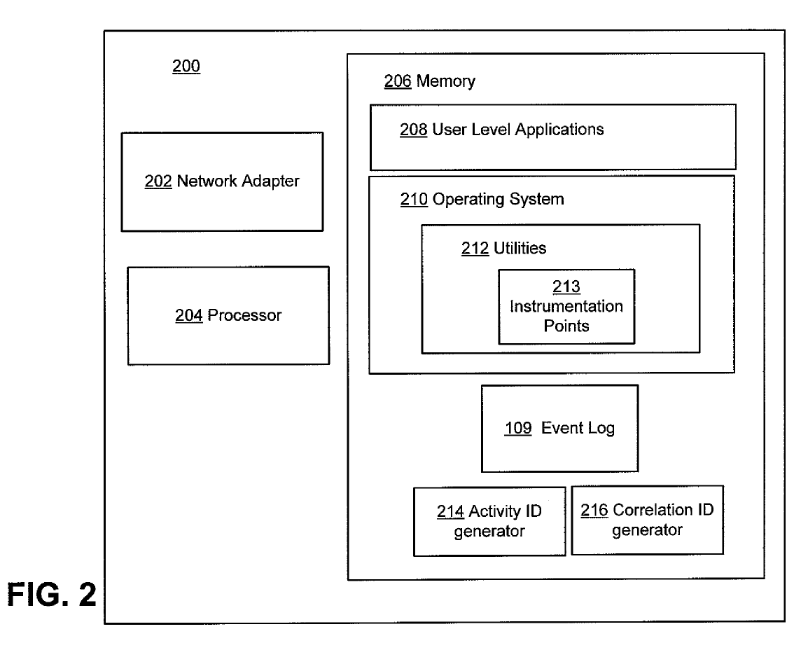

FIG. 2 is a block diagram illustrating a conceptual example of components that may be included in a computing device 200 in which some embodiments of the invention may be implemented. Components shown within memory 206 in this example may be computer-executable instructions or computer data structures located in any suitable computing device (e.g., devices 102, 104 and 106 shown in FIG. 1) and its components. Though, it should be appreciated that these components alternatively may be hardware components in some embodiments. It should be appreciated that FIG. 2 illustrates components of computing device 200 by way of example only and that computing device 200 may include any other suitable components. Moreover, each of the illustrated components may be combined with other component(s) and may comprise one or more sub-components.

Computing device 200 is operable to execute activities interacting within the device and activities that may interact with other activates over a network (e.g., network 100). Though, computing device 200 may execute activities in any suitable manner.

Computing device 200 may include at least network adapter 202, processor 204 and memory 206. Though, computing device 200 may include any other suitable components. Network adapter 106 may be used to communicate with other devices connected to any suitable wireless or wired network such as, for example, network 100. Memory 206 stores data and instructions to be processed and executed by processor 204. Processor 204 enables processing of data and execution of instructions.

Memory 206 may include computer storage media in the form of volatile and/or nonvolatile memory such as read only memory (ROM), random access memory (RAM) and any other memory. Computing device 200 may also include other removable/non-removable, volatile/nonvolatile computer storage media.

By way of example, and not limitation, FIG. 2 illustrates that memory 206 may include user level applications 208 that may be executed in operating system 210 and operating system-level utilities 212 also executed in operating system 210. It should be appreciated that memory 206 may include any other application programs, program modules, program data and other entities not shown in FIG. 2 for simplicity of representation. The operating system may be the Microsoft® WINDOWS® operating system, though other suitable operating systems may be substituted as the present invention is not limited in this respect.

Utilities 212 are shown by way of example only to contain what is referred to by way of example only as instrumentation points 213. Theses are the points at which, if reached during execution of software components executing within an activity, an event related to the points may be recorded as part of an event trace. In some embodiments, the contextual tracing model the recorded events are marked with an activity identifier for the activity in which the instrumentation point 213 is reached.

The activity identifier may be associated with the activity when it is first created. When a log containing the recorded events is processed, the activity identifiers recorded along with information on the events of interest may be used to tie the events to specific activities. It should be appreciated that, though the instrumentation points 213 are shown within the operating system 210 only, that is not a limitation on the invention. Any application or other component executed in computing device 200 may include points identical or similar to instrumentation points 213.

In addition to calls to operating system utilities, events may be logged based on changes of state within an activity. In some embodiments, each activity may be modeled as a state machine. Thus, a state diagram may be used to model the activity and certain events occurring in the activity may be modeled as nodes in the state machine. Transitions between the states as the activity executes may be modeled as edges between the nodes as shown in more detail below.

Memory 206 may include an event log 109 also shown in FIG. 1 Event 109 may store any suitable information associated with events to be logged as activities are executed on computing device 200. It should be appreciated that the invention is not limited to any particular information that may be recorded into event log 109 and any trace information may be stored in event log 109. Event log 109 may be accessed by a user of computing device 200 via any suitable interface, such as a graphical user interface. An administrator may access event log 109 to monitor performance of the activities executed in computing device 200. The information recorded in event log 109 may be used for any suitable purposes, particularly to identify chains of causation for multiple executing activities comprising streams of events, including interacting activities. Though, the location at which event log 109 is analyzed, and by whom, is not a limitation of the invention. The event log could, for example be transferred to a development team in another location where it is analyzed.

Memory 206 may also include component(s) in which activity and correlation identifiers may be generated. Such components are shown by way of example only as “Activity ID generator” 214 and “Correlation ID generator 216.” It should be appreciates that these components may be any suitable components and may comprise software, hardware or combination thereof. These components may generate activity ID's for activities as they are initiated and correlation IDs to identify interactions between activates as they occur respectively. These values may be generated in any suitable way.

In some embodiments, a size of activity identifiers for monitored activities may be a default size. Also, in some embodiments, activity identifiers may have variable sizes. In one embodiment of the invention, a size of the activity identifier may be based on how long activities executed in the system are being monitored. For example, a longer time to monitor the activities may result in a longer size of activity identifiers to uniquely identify the monitored activities and events within them.

In some embodiments, an activity identifier for an activity may be unique in a computing device on which the activity is executing. Further, a value of the activity identifier may be unique for either the duration of a trace collection for the activity or until the activity completes, upon which the activity identifier may be reused by a newly created activity.

A size of the activity identifier may be based on duration of an activity trace and what may be defined as a rate of change in space. The activity trace may comprise collected and recorded information on events occurred within a number of activities. For purposes of some embodiments of the invention, space may be defined as a computing continuum in which logical instructions execute. A change in the space may be indicated by an event. In the contextual tracing model according to some embodiments, such an event may represent creation of an activity. In other words, the size of the activity identifier may be directly proportional to how long the trace collection takes place and how many activities are created and need to be uniquely identified using activity identifiers.

In one embodiment, the size of the activity identifier may be based on a maximum number of activities that can be created during the trace collection. Thus, a minimum size of the activity identifier, in a number of bits, may be defined as follows:

$$f ( {t}_{duration} , {t}_{creation} ) = \{ \begin{matrix}∞ , & {t}_{creation} = 0 \\ 0 , & {t}_{duration} = 0 , {t}_{creation} > 0 \\ 1 , & {t}_{duration} > 0 , {t}_{creation} > 0 , {t}_{duration} \leq {t}_{creation} \\ ⌈ {log}_{2} ( ⌈ \frac{{t}_{duration}}{{t}_{creation}} ⌉ ) ⌉ , & {t}_{duration} > 0 , {t}_{creation} > 0 , {t}_{duration} > {t}_{creation}\end{matrix}$$

where the value t_{creation} represents a minimum time required to create the activity which may represent a change in the computing continuum, while the value t_{duration} represents the duration of the trace collection. For example, when the trace duration is 100 and the creation time for the activity is 10, the above equation provides a size for an activity identifier having 11 different values which requires 4 bits.

Furthermore, in some embodiments, the contextual tracing model may enable generation of variable-sized activity identifiers since duration of a trace may not be known a priori. As a practical solution, the duration of the trace may be inferred from a service level agreement for particular workloads. Thus, different workloads may have size for activity identifier differently for the analysis performed across workloads.

Correlation identifiers may be generated using known techniques for generating unique vales. Though, transferring a correlation identifier between interacting activities takes up resources. Therefore, it may be desirable to select a size of the correlation identifier so that fewer resources are utilized while still satisfying a uniqueness requirement for the identifier. Because a correlation identifier uniquely identifiers this transfer of data between the two or more spaces for the duration of a trace, in some embodiments, a size of the correlation identifier may be based on a rate of data exchange between the two or more spaces.

In one embodiment, the size of the correlation identifier may directly depend on a maximum removal and/or insertion rate (i.e., a data transfer rate) between multiple spaces where interacting activities are executed. For example, if a maximum rate of the data transfer is 100, then the correlation identifier may be required to satisfy at least 100*t_{duration} unique values.

Furthermore, when determining a removal or insertion rate within a computing device or any other component(s) executing interacting activities, a manner of the removal or insertion may be taken into account. For example, writing data via shared memory may have a different overall throughput as compared to writing the data into a named pipe. Therefore, determining a value of the insertion to and/or removal from a space may take into account internal mechanisms which are employed for a particular workload.

In some embodiments in which the contextual tracing model is employed, a size of the correlation identifier may be automatically set to a default size required to guarantee uniqueness across an infinite time, but still enable reducing the size of the correlation identifier based on a particular operating workload and topology of the components executing interacting activities transferring the correlation identifier between them as part of the interaction.

Embodiments of the invention will be described below as implemented within computing device 200. However, it should be appreciated that embodiments of the invention are not limited in this respect, and any suitable computing device (e.g., any of the computing devices shown in FIG. 1) may be substituted.

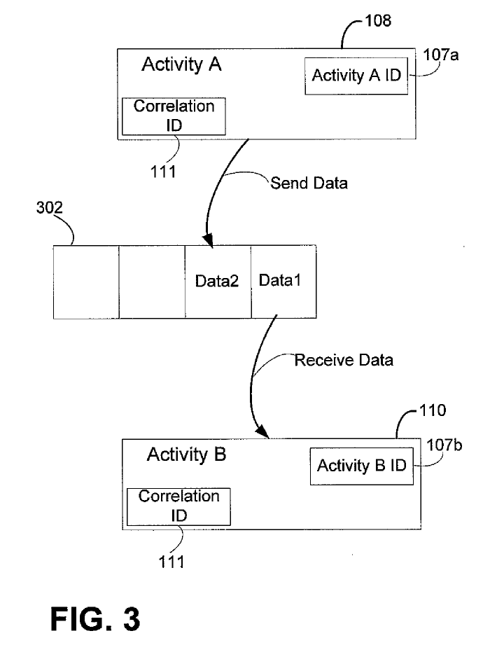

As discussed above, activities for which event traces are being logged may interact. The activities may interact across any boundary. FIG. 3 illustrates an example of such interaction between activities. Thus, FIG. 3 shows a process in which an activity such as activity A 108 transfers data to an activity with which it interacts such as activity B 110. It should be appreciated that activities A 108 and B 110 are shown by way of example only and any suitable activities may interact across any suitable boundary.

In FIG. 3, activity A 108 has activity identifier 107a shown as an “Activity A ID.” Similarly, activity B 110 has activity identifier 107b shown as an “Activity B ID.” Activity identifiers 107a and 107b may be generated to uniquely identify each of the activities A and B, respectively, in any portion of a log where events for those activities may be recorded. When information on events that occur within each of the activities is recorded (e.g., in event log 109) along with their respective activity identifier, the activity identifiers allow a stream of events within each of the activities to be reconstructed.

Conceptually, interactions between activities in a computer system may be performed through queues: a sender copies data to the queue, and a receiver copies data from the queue. The queue may be used to model any interaction between one activity and another activity. Though, it should be appreciated that other mechanisms may be employed to facilitate the interaction.

FIG. 3 shows that when activity A 108 interacts with activity B 110, activity A 108 may place data, such as a work packet, in a queue shown as element 302 in FIG. 3. Queue 302 is shown to include data denoted as “data1” and data denoted as “data2.” Activity B 110 receives the data transferred to it by activity A by accessing the queue. Thus, FIG. 3 shows that activity B 110 accesses data “data1” in the queue where it has been placed by activity A 108. Also, activity A 108 has places new data, “data2” in the queue for activity B 110 to receive.

FIG. 3 also shows that each of the activities A 108 and B 110 interacting by transferring the data between them includes a correlation identifier 111. In this way, both activities A 108 and B 110 may have the same correlation identifier to associate with an event logged to indicate the interaction.

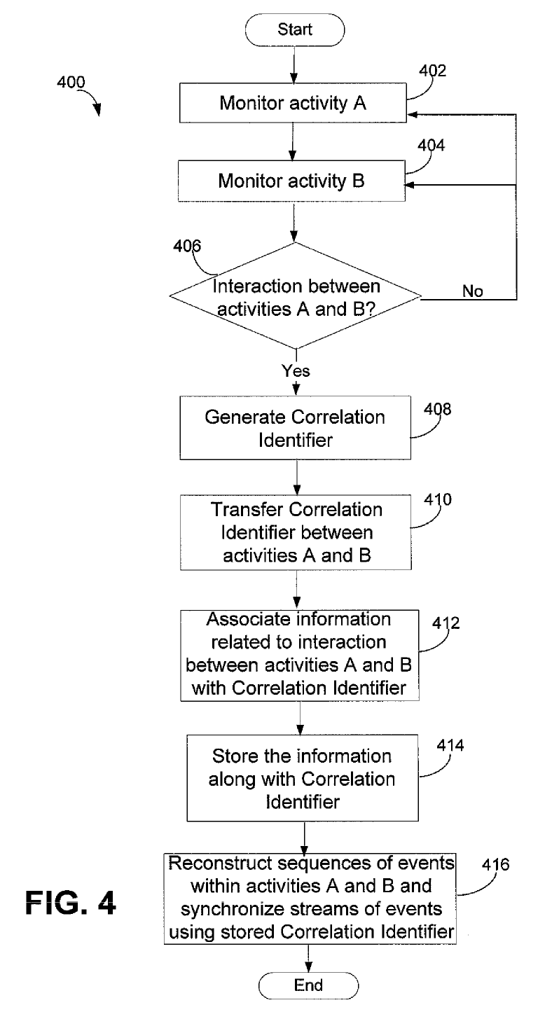

FIG. 4 illustrates a process 400 of operating a computer system using contextual tracing according to some embodiments of the invention. Process 400 may start at any suitable point. For example, process 400 may start when computer 200 starts operation or only when some activity of interest is initiated. Alternatively, user controls may be used to initiate the process 400.

Here, process 400 is shown to monitor an activity A at block 402 and an activity B at block 404. The monitoring comprises recording information on events (e.g., in an event log) that occurs as each activity is executed. It should be appreciated that activity B is shown to be monitored after activity A for illustration purposes only as events within activities A and B may be monitored in any suitable order. Moreover, since activities A and B may be executed in parallel, the information on the events within these activities can be recorded as the events occur, and therefore may be interleaved in a log file, as described in more detail below. The events occurring as part of each activity are recorded in a log marked with a respective activity identifier which allows associating that event with the activity when information in the log is processed.

Furthermore, two activities being monitored are shown by way of example only as any number of activities can be monitored using the contextual tracing. A number of monitored activities and duration of each activity trace may be determined using any suitable method. For example, an activity trace may comprise events of the activity from the beginning of execution of the activity until it is canceled, and the recorded events may include events identifying initiation and termination of the activity.

Though, events may be logged over only a portion of the time that the activities are active and the logging may occur after the activities are executed. For example, when a potential problem is detected (e.g., a system is working slowly), at first, a short-duration snap of the executed activities may be taken and a duration of a trace may therefore be short. Next, if it is determined that more information may be required, traces of increasingly longer duration may be obtained. Thus, duration of the trace may depend on amount of desirable information.

At decision block 406, process 400 may determine whether there is interaction between activities A and B. This may be determined in any suitable manner, including by the nature of the operating system utilities called from an activity initiating interaction.

When it is determined at decision block 406 that there is the interaction between activities A and B, process 400 may follow to block 408 where a correlation identifier for that interaction may be generated, such as by correlation ID generator 216 (FIG. 2). The correlation identifier may be unique for a time interval during which activities A and B and any other interacting activities exist.

When it is determined at block 406 that no interaction exists between activities A and B, process 400 may return to blocks 404 and 402 to continue monitoring by recording events for activities A and B. It should be appreciate that, as activities A and B are being monitored which may be performed using any suitable methods including those known in the art, events of interest (e.g., signpost events described in more detail below) and related information may be recorded for each of the activities along with a respective activity identifier.

After the correlation identifier has been generated at block 408, the correlation identifier can be transferred between the interacting activities A and B at block 410 as part of the interaction. Process 400 may then proceed to block 412 where information on the interaction, such as for example the role the activity played in the interaction (e.g., the “Send” and “Receive” state of each activity which refer to respective signpost events), may be associated with the correlation identifier to uniquely identify the interaction. For each of the activities A and B, respective information identifying the event relating to the interaction may be associated with the correlation identifier. Thus, if activity A transfers data to activity B, activity A may associate information identifying the “Send” event with the correlation identifier.

In some embodiments, the activity A may transfer data to activity B by placing the data into a queue as described above in connection with FIG. 3. Though any suitable mechanism may be used.

In some embodiments, the activities A and B interact across a network boundary and the correlation identifier may be transferred between the activities A and B as part of a network packet. The processing of the packet may comprise extracting the correlation identifier, which may then be used to mark information related to the interaction upon which the marked information may be recorded.

Regardless of how data including the correlation identifier is exchanged, at block 414, the information identifying the event relating to the interaction may be stored along with the correlation identifier. Block 414 is shown to follow block 412 by way of example only since for some of the interacting activities (e.g., for an activity that sends data to another activity) the information related to the interaction may be stored prior to the transfer of the correlation identifier shown in block 410.

At block 416, the information stored at block 414 may be used to reconstruct sequences of events within activities A and B and to synchronize streams of events using the correlation identifier.

The activity identifier may be used to uniquely reference a particular activity, while the correlation identifier may be used to identify a particular interaction at a particular point in time between two activities being executed. Such reconstructed information may be used for debugging, code maintenance or other functions.

To facilitate understanding the context of logged events when analyzing traces, in some embodiments, events related to state transitions within activities may be logged. This information may allow the state of each activity, at any point within a trace, to be reconstructed. Accordingly, each activity may be modeled as a state machine represented with a state diagram. The state diagram for an activity may mirror a state diagram of software executing within the activity. Thus, an activity comprises a representation of execution states of a set of components that are performing a certain transaction. In the contextual tracing model according to some embodiments of the invention, events, referred to as signpost events, may be recorded to indicate state transitions.

Accordingly, an event in a trace may be logged when a component executing within the activity transitions from one state to another. The event may be marked in such a way that a previous state is indicated as well. Each event is recorded along with an activity identifier which ties that event to a particular activity. Thus, during analysis of the recorded information on multiple events, execution of a single activity may be modeled.

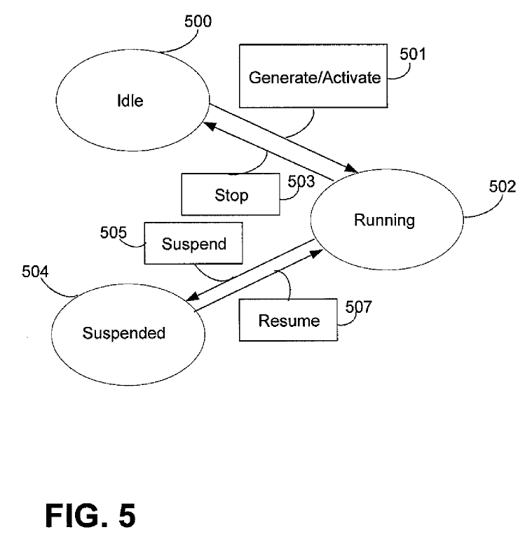

FIG. 5 illustrates an example of three key states in a lifetime of an activity. Thus, an activity (e.g., any of the activities 108, 110, 112 and 114) may be in an “Idle” state 500 indicating that the activity does not exist, in a “Running” state 502 or in a “Suspended” state 504. The activity may transition from one of the states to another in accordance with the state diagram of FIG. 5. Thus, there may be transitions, or signpost events, between the “Idle” 500 and “Running” 502 states, and between the “Running” 502 and “Suspended” 504 states. It should be noted that, in one embodiment, signpost events may exist for valid transitions only. For example, as shown in FIG. 5, there may be no transition between the “Idle” 500 and “Suspended” 504 states.

Accordingly, the activity may transition from “Idle” state 500 to “Running” state 502 and this transition may be associated with “Generate/Activate” events 501 indicating respective activation or generation of an activity as shown in FIG. 5. The “Generate/Activate” signpost events 501 may be used to indicate generation of an activity when a new activity is initiated by a suitable component. For example, when a computing device powers up (e.g., when a user presses a power button) activities may be initiated by software or hardware components in the device. A “Generate/Activate” signpost event 501 may be logged to indicate activation of the activity. Though, activities may be generated by other activities, and this signpost event may be logged when this activity is activated by another activity.

An activity in “Running” state 502 may transition back to “Idle” state 500 which is shown as a “Stop” event 503. “Stop” event 503 may be logged. Alternatively, an activity in “Running” state 502 may transition to “Suspended” state 504 which indicates a suspended state of the activity shown as an event “Suspend” 505. A transaction from “Suspended” state 504 to “Running” state 502 may indicate that the activity is resumed which is shown as an event “Resume” 507.

While three basic states that may be used to model any activity according to some embodiments, more granular marking of events within an activity may be useful to capture elapsed time of specific stages in the activity. Indeed, when multiple components operate to execute the activity, the more granular marking of the events may allow better capturing of streams of the events.

Thus, in one embodiment, signpost events such as “Begin” and “End” may be recorded, or logged. The “Begin” event may be logged when work is performed as part of the activity by a subcomponent, while the “End” event may indicate that work has ended by a subcomponent. Thus, the “Begin” and “End” events may be used to mark intermediate stages in the lifetime of an activity, rather than to signify a beginning or an end of the activity.

Furthermore, the “Stop” event 503 which may be used to mark a normal termination of an activity, additional signpost events may be used to provide more details for stopping of the activity. However, an activity may terminate abnormally, which may be caused by the activity itself or by another activity. Accordingly, an “Abort” event may be logged in order to indicate that the activity has stopped processing before its normal termination, while a “Cancel” event may be used to indicate that another activity has caused an abnormal termination of this activity.

Thus, for an activity, signpost events shown in Table 1 may be logged.

TABLE 1

| Signpost Class | Event |
|---|---|
| Start and Stop of an | Generate/Activate |
| Activity | Stop |
| Suspend/Resume an | Suspend |
| Activity | Resume |
| Cancel (Controlled | Abort |
| Stop), | Cancel |
| Abort (Abnormal | |
| Stop) of an Activity | |
| Begin and End a | Begin |
| subsection of an | End |
| activity | |

As discussed above, in a computing environment, activities may interact, and an indication of this interaction may be recorded in connection with a correlation identifier. In some instances, the interactions may cause changes to the state of one activity. In these instances, a state transition event may be recorded in connection with a correlation identifier. For example, the “Activate” signpost may be logged to indicate an event when one, parent activity initiates another, child, activity. The correlation identifier may be used to tie the parent and child activities together. Similarly, the “Cancel” signpost event may also require a correlation identifier, because the activity in which the “Cancel” signpost event occurs is abnormally terminated by another executing activity. Thus, the correlation identifier is used to tie the communication between two or more activities that can result in a state change for either the sending or receiving activity.

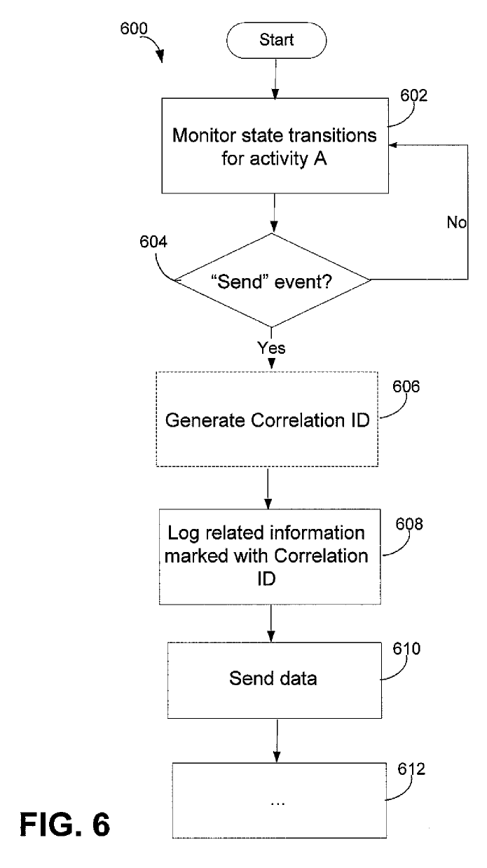

Process 600 in FIG. 6 illustrates operating an activity that interacts with another activity. Process 600 shown in FIG. 6 may start at any suitable time. For example, process 600 may start when tracing of events within various activities executed in the computer system is initiated. Process 600 may continue to block 602 where events within an activity, such as an activity A, may be monitored. These events may include state transitions as well as other events, such as calls to operating system utilities or other instrumented components.

Process 600 may continue to block 604 where it may be determined whether a current event occurred in the activity A is a “Send” event. The “Send” event may be an event relating to an interaction between the activity A and any other activity currently executed in the computer systems. For example, the activity A may transfer the data to an activity B with which it interacts.

When it is determined at block 604 that the event is the “Send” event, process 600 may continue to block 606 where a correlation identifier may be generated for the interaction. As discussed above, the correlation identifier may be of any suitable format.

After the correlation identifier has been generated at block 606, process 600 may follow to block 608. The information identifying the send event may be marked with the correlation identifier in a log (e.g., event log 109). Thus, the activity A logs the related information marked with the correlation identifier to identify that the send event has occurred within the activity A. Process 600 may then continue to block 610 where the activity A may send data to the activity with which it interacts (such as to the activity B). This data may include the correlation identifier as well as other data describing the nature of the interaction. Process 600 may then continue as the activity A executes and events occurring in the activity define different states of the activity which is shown schematically at block 612.

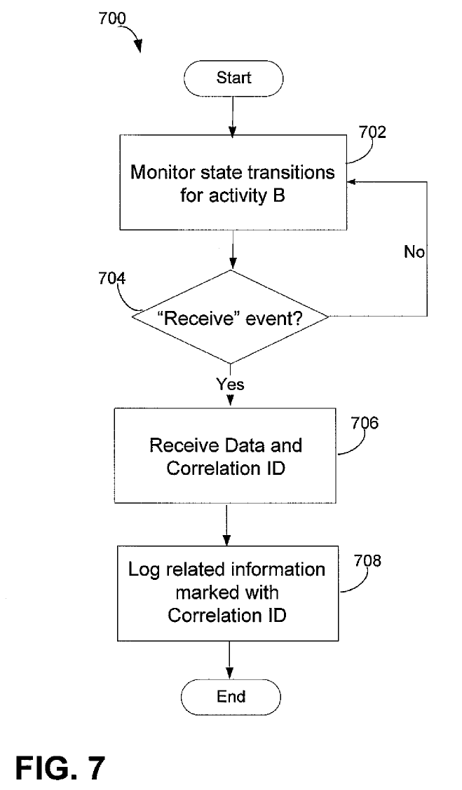

FIG. 7 illustrates a process 700 in which activity, such as the activity B, interacting with an activity such as, for example, the activity A, receives the data that has been transferred to it by an activity with which it interacts. Process 700 may start at any suitable time. For example, process 700 may start when the activity B is generated by a component that executes the activity. Also, the activity B may start when another activity activates it as a child activity.

Process 700 may continue to block 702 where transitions between states within the activity B may be monitored as well as other events, such as calls to operating system utilities or other instrumented components. From block 702, process 700 may continue to a decision block 704 where it may be determined whether a current event is a “Receive” event.

When it is determined that a current event is the “Receive” event, process 700 may continue to block 706 where the data transferred by the activity A may be received by the activity B. The data that is received by activity B may include the correlation identifier generated by the activity A at block 606. As described above, the data may be transferred through a queue, or over a network or in any other suitable way. When the activity B receives the data, the activity B retrieves the data from the queue and then processes the data to extract the correlation identifier. Process 700 may then follow to block 708 where the information related to the receive event may be stored along with the correlation identifier. The information is stored for future reconstruction of the interaction between the activities A and B. Process 700 may then end.

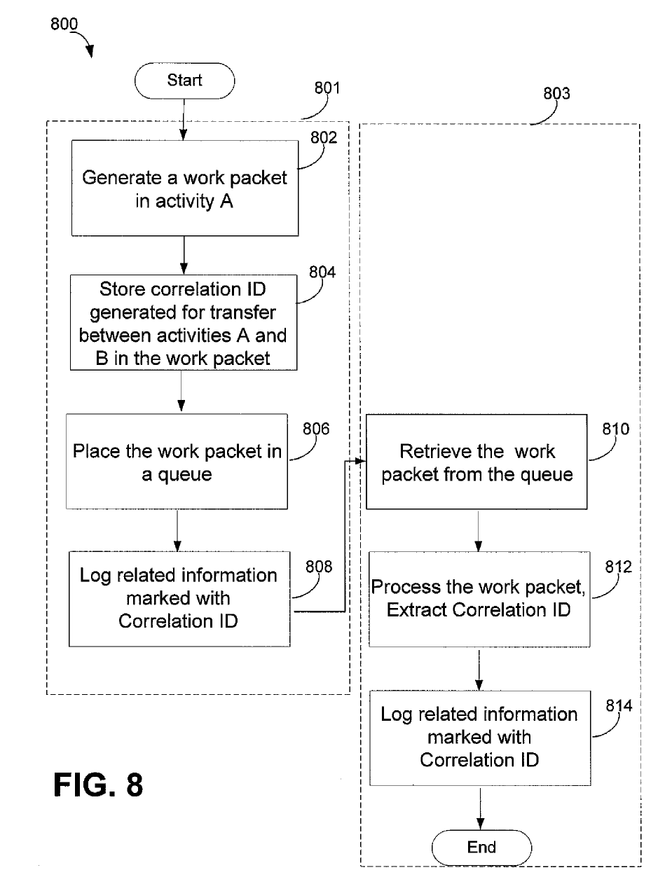

As described above, in some embodiments, a correlation identifier may be transferred between two interacting activities as part of a work packet. The work packet may comprise any suitable data or any suitable format. FIG. 8 shows a process 800 in which two interacting activities A and B executed on respective component(s) 801 and 803 interact.

Process 800 may start at any suitable time. For example, process 800 may start when an activity such as activity A is executed in any one or more suitable components (e.g., component(s) 801) and events occurring within this activity are tracked as it is executed. Process 800 may follow to block 802 where a work packet may be generated in activity A.

Process 800 may then follow to block 804 where the correlation identifier generated for transfer between activities A and B may be stored in the work packet. As described above, the correlation identifier may be generated when activity A interacts with another activity such as activity B, for example, by transferring data to the activity B. Process 800 may then continue to block 806 where the work packet may be placed in a queue.

Next, process 800 may continue to block 808 where information related to the interaction between the activities A and B and marked with the correlation identifier may be placed in a log, such as event Log 109. Such an event may be recorded as a “Send” event.

Next, process 800 may follow to block 810 within the activity B. At block 810, the activity B may retrieve the work packet from the queue where it has been placed by the activity A. Process 800 may then continue to block 812 where the activity B may process the work packet and extract the correlation identifier from the work packet. If the correlation identifier is an active identifier that comprises one or more instructions, the instructions may be processed as well. The extracted correlation identifier may then be used to mark related information with the correlation identifier within component(s) 803 executing the activity B. A “Receive” event may be logged at this point and marked with the correlation identifier.

It should be appreciated that even though process 800 is shown for two executing activities defined as activities A and B, any number of activities may be executing and interacting by, for example, exchanging data. Moreover, it should be appreciated that even though a certain number of processes is shown for each of the activities A and B, each activity may comprise a multiple number of events which constitute event streams of a respective activity. Thus, FIG. 8 illustrates that the interacting activities may place data that they exchange on the queue and other various processes may be performed within each of the activities. Points where the interacting activities A and B interact by exchanging data may be used to correlate, or synchronize, the streams of events within each of the activities A and B.

In some embodiments, where activities such as, for example activities A and B, interact over a network, the contextual tracing model may utilize the OPTIONS field of the IPv4 and IPv6 headers in order to transfer correlation identifiers. A minimum size of an IPv4 header may be 5 words, with each word being 32 bits, and the maximum allowed size of an IPv4 header may be 15 words, or 480 bits. When transferring the correlation identifier as part of the IPv4 header, the minimum size of the IPv4 header may be 160 bits for the IPv4 header plus 32 bits for the OPTIONS header plus a size of the correlation identifier which includes an identifier header. For example, if the correlation identifier is a Globally Unique Identifier (GUID), then a total size of the IPv4 header may be 352 bits.

The IPv4 header may be specified using the OPTIONS field and certain bits in the OPTIONS header may be required to be set. Specifically, default OPTIONS header may be as follows:

OPTIONS.Copied=1—this ensures that if an IPv4 packet is fragmented, a structure of the correlation identifier may be duplicated across all fragments.

OPTIONS.Class=2—this specifies that the OPTIONS field contains information about measurement and debugging.

OPTIONS.Number—this corresponds to either a correlation identifier or an activity identifier mapped to an IP number.

OPTIONS.Length—this represents a size of the OPTIONS payload which may include the correlation identifier.

In the case of normal operation, the structure of the correlation identifier may follow the OPTIONS header. Thus, the structure may contain 32 bits of the correlation identifier header followed by the correlation data itself. The maximum size of the correlation identifier may be 247 bits.

One example of a data transfer between two components executing respective interacting activities is given below. A sending component may be executing an activity with the following header: {Version=1, IDType=Activity, ValueType=GUID, ValueSize=128}. The sending component may then create a correlation identifier with the following header: {Version=1, IDType=Correlation, ValueType=GUID, ValueSize=128} followed by a GUID value. Prior to sending the packet, the sending component logs into a log an event with this correlation identifier and its activity identifier. Thus, the log may contain the event with these two headers and their corresponding GUID values. The receiving component may be executing an activity with the following header: {Version=10, IDType=Activity, ValueType=ULONG, ValueSize=32}. It may receive the packet, and then log an appropriate event with its activity and the correlation identifier sent from the sending component, whose header is {Version=1, IDType=Correlation, ValueType=GUID, ValueSize=128}. It may be noted that the sending and receiving components may not need to share a common identifier header structure.

Although in normal operation sending and receiving components may need to only share the correlation identifier, in some scenarios, the sending and receiving components may transfer both the activity and correlation identifiers. In such cases, the same method that is used to send the correlation identifier may not be appropriate, because by doing so a size limit of the IPv4 header may be exceeded. Therefore, in order to accommodate both the activity and correlation identifiers, a change may be made to the OPTIONS payload that contains the header and data for the activity and correlation identifiers, respectively.

The headers of the activity and correlation identifiers contain four fields: a version of the header (5 bits), a type of the header (3 bits that correspond to whether the identifier represents the activity or interaction between the activities), a type of value (8 bits which indicate whether a ULONG, GUID or other identifier is used to represent the identifier), and a size of the identifier (16 bits). Both the type and size fields may be included to handle scenarios where different computing devices running different operating systems are not able to make any assumptions about the uniqueness of a particular identifier based exclusively upon its size.

A type CUSTOM may enable a component to specify an identifier that is greater than 128 bits in size. When both the activity and correlation identifiers are specified as CUSTOM, the two identifiers combined with their respective identifier headers may not fit in the IPv4 header. Thus, in this particular instance when transferring both the activity and correlation identifiers using IPv4, a compressed identifier header may be used. The Value Size field may be removed from the activity and correlation identifier header structures. This, in turn, may require that the sending and receiving components can both derive the same length of identifier based upon the type of identifier. For example, if the type is specified to be a ULONG, both the sending and receiving components may be required agree that the size of the identifier is 32 bits. When the appropriate signpost event is logged (by either the sending or the receiving component), it may log an “uncompressed” header. This may be performed to enable analysis tools that process the event log to generically consume the headers, regardless of understanding of a mapping between the ValueType and ValueSize for a particular environment.

An example below illustrates a scenario where both the activity and correlation identifiers are being transferred. In this case, the sending component's activity identifier header is: {Version=1, IDType=Correlation, ValueType=GUID, ValueSize=128}. Likewise, when the correlation identifier is created, the following header is generated: {Version=1, IDType=Correlation, ValueType=GUID, ValueSize=128}. The sending component may then log a signpost event to indicate that it is sending data. However, when the sending component then proceeds to send the packet, the two headers may be compressed such that the following of each is sent: {Version=1, IDType=Correlation, ValueType=GUID}. The sending component may then need to decipher the length and uniqueness criteria from the type field. On the receiving component, an activity may be executing with the following header: {Version=10, IDType=Activity, ValueType=ULONG, ValueSize=32}.

When the packet is received, the receiving component may choose to manipulate a current state based on the activity identifier, but may need to only log the correlation identifier. When it logs this signpost event, it may “uncompress” the correlation header. The benefit of logging the header in full may be that an analysis tool need not understand the mapping between the Value type and Value size since the identifier (with its header) is essentially self-describing. Thus, before the receiving component logs the appropriate signpost event, it may expand the correlation identifier out as follows: {Version=1, IDType=Correlation, ValueType=GUID, ValueSize=128}. It may be required to make the mapping between ValueType and ValueSize, which is also used to interpret the value of the correlation identifier.

In one embodiment, the correlation identifier may be transferred between two interacting activities in accordance with IPv6 protocol. If the correlation identifier and activity identifier are being transferred using the IPv6 protocol, then a different workflow may be required. To transfer the identifiers using IPv6, the Destination Options Header may be leveraged. A value in the NEX_HEXT header may be set to 60. In the Destination Options Header that is dedicated to transferring the identifiers to the receiving component, there may be a link to the NEXT_HEADER that would have originally followed the primary IPv6 header. This may honor the OPTIONS header that the sending component had originally intended to transfer to the receiving component.

In the Destination Options Header that corresponds to the correlation (and optionally to the activity) identifier, the OPTION_TYPE field may be set as follows: the highest-order two bits of OPTION_TYPE may be set to 00, which instructs components that do not understand the correlation and activity identifier to skip over this field. The next bit may be set to 0 which indicated that the option data is not to be changed en-route, and the remaining 5 bits of OPTION_TYPE may be used to indicate that the option corresponds to diagnostics (e.g., a value of 10000).

The OPTION_DATA of the Destination Options Header may include the header of the correlation identifier as well as the actual value. However, the contextual tracing model may specify a maximum identifier value of 8198 octets. The IPv6 protocol allows for sending a maximum of 255 octets in the options header data payload. Therefore, in scenarios where the correlation (and potentially the activity) identifier is greater than 255 octets (or 2040 bytes) in size, the identifier may need to be fragmented. Thus, the identifier payload may be divided into several fragments at the sending component and transferred to the receiving component. To indicate that an identifier is being fragmented, the most significant bit of the ValueType field may be set. When this most significant bit of the ValueType is not set, the identifier data may not be fragmented. For example, when the sending component is transferring both the activity and correlation identifiers, the activity identifier may fit into the options data payload, but the correlation identifier, when added to the payload, may take the payload size above 255 octets. In this case, the sending component may need to set the most significant bit of the ValueType field of the correlation identifier, and then fragment the correlation identifier. The remaining seven bits of the ValueType field may be used as they were in the case of IPv4. The receiving component, upon receiving the fragmented pieces of the identifier, may then need to create the full identifier value again.

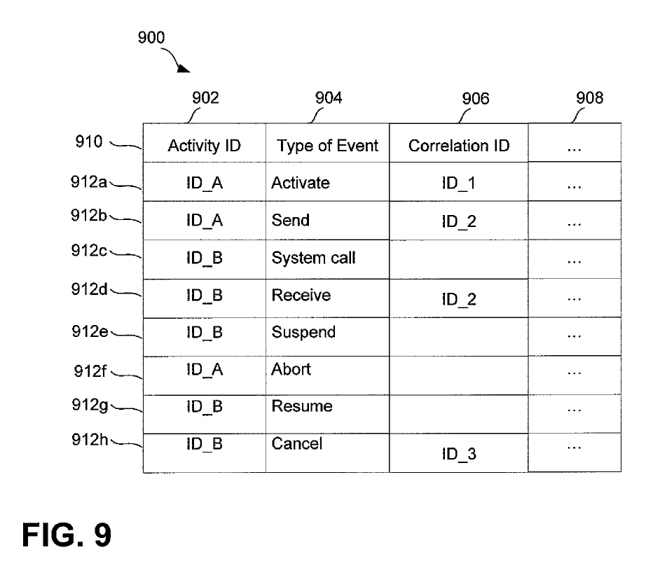

As discussed above, events in activities may be recorded in memory for later processing. FIG. 9 shows an example of an event log 900 which may be any suitable data storage (e.g., event log 109) wherein events occurring within activities being executed and related infromation may be stored.

By way of example only, event log 900 in FIG. 9 is shown to comprise four columns. However, it should be appreciated that event log 900 may comprise any suitable number of columns. Each row besides the first row represents an event that occurs in an activity when it is executed. As discussed above, events may be signpost events

In FIG. 9, first column 902 comprises activity identifiers for each of the recorded events. Second column 904 includes information identifying a type of a logged event. Third column 906 indicates whether and which correlation identifier has been recorded for this particular event. The last column 908 schematically shows that event log may include any suitable information beside the information shown in FIG. 9. For example, event log 900 may include information on a date and a time when the event occurred. Also, the event 900 may include information on a name of a user that was logged in on a computer when the event occurred, a name of the computer where the event occurred and any other suitable information.

Row 912a in event log 900 comprises an event of a type “Activate” marked with “ID_A.” For example, when an activity A is activated by one or more suitable components executing that activity such “Activate” event may be logged. As described above, some of the events besides the events related to interaction between activities may require a correlation identifier to be recorded for such events. Thus, the “Activate” event for the activity A may be marked with the correlation identifier schematically shown as “ID_1.”

Row 912b comprises a “Send” event for the activity A. This record indicates that activity A sends data to another activity with which it interacts. For the “Send” event, the correlation identifier “ID_2” is recorded in column 906. Row 912c comprises an event of another type, such as a “System call,” for an activity such as an activity B. This entry shows by way of example that any suitable events may be logged for an activity such as function, system calls and others. The “System call” is stored along with an activity identifier for the activity B schematically shown as “ID_B.”

Row 912d comprises a “Receive” event marked with activity identifier “ID_B.” This record shows that correlation identifier “ID_2” is recorded for this “Receive” event in activity B. Thus, the interacting activities A and B transfer data between each other, among with the correlation identifier shown here as “ID_2” which is unique for the interaction recorded in rows 912b and 912d. In this example, the activity A sending data to activity B transfers the correlation identifier “ID_2” to activity B.

Row 912e includes a “Suspend” event that may happen as activity B executes. This “Suspend” event is marked with activity identifier “ID_B” generated for activity B. As described above, when an activity receives some data from another activity the execution of the receiving activity may be suspended.

Next, event log 900 includes row 912f where activity A may be aborted which is shown as an event of type “Abort.” Like all events in activity A, such event is marked by an activity identifier “ID_A.” As described above, the “Abort” event may be an abnormal stop of an activity A which happens due to internal reasons within activity A.

FIG. 9 shows that row 912g contains the “Resume” event marked with “ID_B” identifier for activity B. The “Resume” event indicates that activity B which has been suspended as shown in Row 912e now resumes executing. Finally, row 912h of event log 900 includes a “Cancel” type of event marked by an activity identifier “ID_B” for activity identifier B. Such “Cancel” event may be marked with a correlation identifier shown in this example as “ID_3.” As described above the “Cancel” event may occur when another activity cancels or stops the execution of activity B. Thus, the correlation identifier transferred from the activity that cancels the execution of activity B may be recorded to later tie activity B with that activity.

Information shown recorded in event log 900 may be referred to as raw information where events which occur within different activities are being logged. This raw information may then be processed and analyzed in any suitable way to provide multiple beneficial results. It should be appreciated that even though event log 900 in FIG. 9 is shown to contain events for two activities such as the activity A and activity B, events for multiple activities may be recorded in the event log as an execute. Also, it should be appreciated that different types of events besides the events described in FIG. 9 may be executed as each activity comprise streams of multiple events.

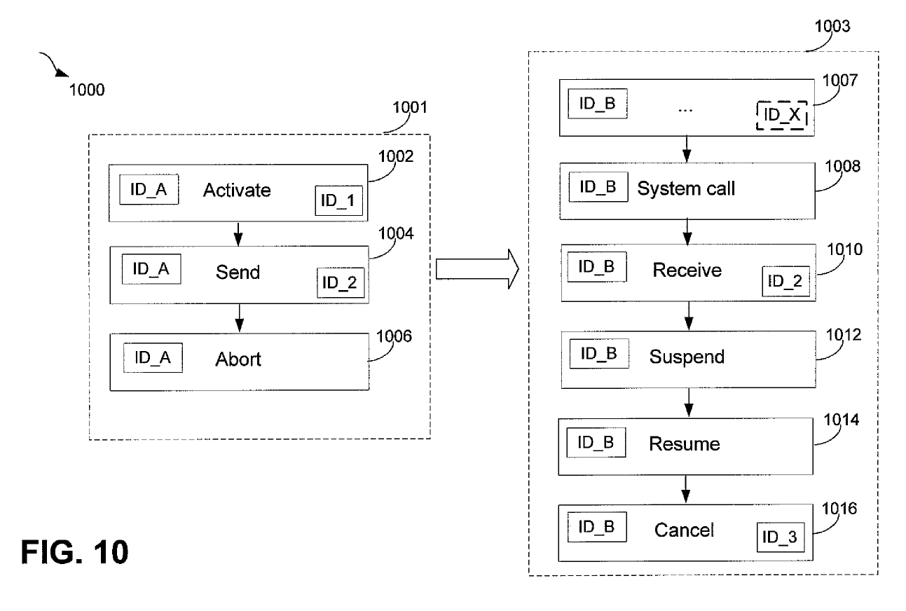

FIG. 10 illustrates a representation 1000, such as on a computer display, of streams of events extracted from event log 900. Here, events that occurred within activity A are shown in synchronization, or correlation, with the events occurred within activity B, as a result of points of interaction between the activities A and B being identified. In this example, the steams of events for each of the activities have been reconstructed using “raw” data recorded in event log 900 shown in FIG. 9.

FIG. 10 shows that a sequence of events within the activity A executed on component(s) 1001 includes “Activate” event 1002, “Send” event 1004 and “Abort” event 1006. Each of events 1002, 1004 and 1006 may be marked by the activity identifier “ID_A” for the activity A. The activity identifier allows identifying that events 1002, 1004 and 1006 occurred within the activity A as it was executed.

Similarly, a sequence of events within the activity B executed on component(s) 1003 includes “System call” event 1008, “Receive” event 1010, “Suspend” event 1012, “Resume” event 1014 and “Cancel” event 1016. Further, FIG. 10 schematically illustrates that the activity B may have other events occurred as part of the execution of the activity B prior to the event shown in FIG. 10. Thus, it should be appreciated that any number of any suitable events may form respective events streams of activities A and B.

Each of events 1008, 1010, 1012, 1014 and 1016 may be marked by the activity identifier “ID_B” for the activity B. The activity identifier allows identifying that events 1008, 1010, 1012, 1014, 1016 and any other events shown at block 1007 occurred within the activity B as it was executed.

The streams of the events occurred within activities A and B executed on different components, or nodes, which may be within a computing device, in respective client and server, in a distributed computing environment and in any other environment may be synchronized using points at which the activities interact. The streams may be synchronized at points of interaction between activities A and B. FIG. 10 shows that activities A and B may be synchronized at a point defined by correlation identifier “ID_2” because it is known that the activities interacted at these points. The correlation identifier “ID_2” allows uniquely identifying this particular interaction “bridging” activities A and B at the interaction point. Identifying such bridging improves performance management, fault detection and diagnosis, debugging and other provides other advantages.

As described in connection with FIG. 9, “Abort” event occurred in activity A is marked with correlation identifier “ID_1” and “Cancel” event occurred in activity B may be marked with correlation identifier “ID_3.” Any other suitable events within an activity may be marked with a correlation identifier which is shown for illustration purposes only as an optional identifier “ID_X” in block 1007. It should be appreciated that activity A may also comprise any other suitable events as it is executed.

Having thus described several aspects of at least one embodiment of this invention, it is to be appreciated that various alterations, modifications, and improvements will readily occur to those skilled in the art.

For example, correlation identifiers are described to be passive codes. The correlation identifier alternatively may be “active,” which indicates that it comprises one or more instructions.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of tracking events within a plurality of activities executing in a computing environment comprising at least one processor, the method comprising:
operating the at least one processor to:
for each of a plurality of interactions between activities of the plurality of activities:
generate a unique identifier;
transfer the unique identifier between the interacting activities as part of the interaction;
associate information identifying an event within each of the interacting activities with the unique identifier, the event within each of the interacting activities relating to the interaction; and
store the information along with the unique identifier.

2. The method of claim 1, wherein the unique identifier comprises one of a value and at least one instruction.

3. The method of claim 1, wherein the interaction comprises:
generating a work packet in a first of the interacting activities;
storing the unique identifier in the work packet;
placing the work packet in a queue;
in a second of the interacting activities, retrieving the work packet from the queue; and
processing the work packet in the second activity.

4. The method of claim 1, wherein the unique identifier is unique during an interval during which the interacting activities all exist and not unique outside the interval.

5. The method of claim 1, further comprising, for each activity of the interacting activities, storing information on at least one state transition of the activity upon a change of a state of the activity from a plurality of states, wherein
the information on the at least one state transition comprises an indicator of the state transition; and
the event relating to the interaction is associated with at least one state from the plurality of states.

6. The method of claim 5, wherein the event relating to the interaction is associated with one of a transfer event and a receipt event.

7. The method of claim 5, further comprising reconstructing a stream of events representing transitions between the plurality of states of each activity using the stored information on the at least one state transition.

8. The method of claim 7, wherein reconstructing the stream of events comprises reconstructing a first stream of events for a first activity of the interacting activities and reconstructing a second stream of events for a second activity of the interacting activities, wherein the first and second activities comprise the event relating to the interaction for which the associated information is stored along with the unique identifier, the method further comprising:
synchronizing the first and second streams of events based on the event relating to the interaction for which the associated information is stored along with the unique identifier.

9. A system comprising at least one computing device having a processor and memory with computer-executable instruction stored thereon that when executed by the processor cause the computing device to perform a method of tracking events within a plurality of activities executing in the at least one computing device, the method comprising:
operating the processor to:
for each of a plurality of interactions between activities of the plurality of activities:
generate a unique identifier;
transfer the unique identifier between the interacting activities as part of the interaction;
associate information identifying an event within each of the interacting activities with the unique identifier, the event within each of the interacting activities relating to the interaction; and
store the information along with the unique identifier.

10. The system of claim 9, wherein the interaction between the interacting activities comprises interaction across a network boundary.

11. The system of claim 9, wherein the interaction comprises:
generating a work packet in a first of the interacting activities;
storing the unique identifier in the work packet;
placing the work packet in a queue;
in a second of the interacting activities, retrieving the work packet from the queue; and
processing the work packet in the second activity.

12. The system of claim 11, wherein storing the unique identifier in the work packet comprises storing the unique identifier as part of a header of the work packet, and wherein transferring the unique identifier comprises transferring the unique identifier in the work packet across a network boundary in accordance with a network protocol.

13. The system of claim 13, wherein the network protocol comprises one of IPv4 and IPv6 network protocol.

14. The system of claim 9, wherein the method further comprises:
for a first activity the interacting activities, recording first events occurring in the first activity; and
for a second activity the interacting activities, recording second events occurring in the second activity, wherein
an indication of each event comprises an indicator of the event; and
the event relating to the interaction is associated with one of a transfer event and a receipt event.

15. The system of claim 14, wherein the method further comprises:
reconstructing a first stream of events for the first activity based on the recorded first events;
reconstructing a second stream of events for the second activity based on the recorded second events; and
synchronizing the first and second streams of events based on the event relating to the interaction for which the associated information is stored along with the unique identifier.

16. At least one computer-readable storage medium having encoded thereon computer-executable instructions that, when executed in a computing environment comprising at least one computer, perform a method of tracking events on the at least one computer, the method comprising:
creating a first activity and a second activity;
recording in at least one log a first stream of events occurring in the first activity;
recording in the at least one log a second stream of events occurring the second activity;
passing a work packet from the first activity to the second activity, the work packet comprising a correlation identifier;
recording an indication of a transfer event in the at least one log along with the correlation identifier; and
recording an indication of a receipt event in the second log along with the correlation identifier.

17. The least one computer-readable storage medium of claim 16, wherein:
the first activity and the second activity have a first and second activity identifiers, respectively;
recording the indication of the transfer event comprises recording of the first activity identifier in conjunction with the correlation identifier; and
recording the indication of the receipt event comprises recording of the second activity identifier in conjunction with the correlation identifier.

18. The least one computer-readable storage medium of claim 16, wherein the first activity and the second activity each comprise a task.

19. The least one computer-readable storage medium of claim 16, wherein the method further comprises:
passing a plurality of work packets between the first activity and the second activity; and
for each of the plurality of work packets, generating a unique correlation identifier.

20. The least one computer-readable storage medium of claim 16, wherein:
recording the first stream of events comprises recording an indication of state transitions in the first activity; and
recording the second stream of events comprises recording an indication of state transitions in the second activity.
